(19) United States
(12) Patent Application Publication
(10) Pub. No.: US 2022/0125682 A1
(43) Pub. Date: Apr. 28, 2022

(54) PILL LOCATOR FOR A PILL CUTTER

(71) Applicant: E-LINK PLASTIC & METAL INDUSTRIAL CO., LTD., New Taipei City (TW)

(72) Inventor: Pin-Yang CHANG, New Taipei City (TW)

(73) Assignee: E-LINK PLASTIC & METAL INDUSTRIAL CO., LTD., New Taipei City (TW)

(21) Appl. No.: 17/081,368

(22) Filed: Oct. 27, 2020

(51) Int. Cl. A61J 7/00

(52) U.S. Cl. CPC A61J 7/0007

(57) ABSTRACT

A pill locator is provided. The pill locator has an edge and a hole. The edge is configured to abut a recess of the pill cutter so that the board is fixed in the recess. The hole is configured to receive a pill, a shape and a size of the hole corresponds to a shape and a size of the pill. Because the pill is fittingly positioned in the hole, the pill may not be moved with respect to the pill locator. With the edge of the board abutting the recess of the pill cutter, the pill locater may not be moved with respect to the pill cutter. As a result, the pill in the pill locater may not be moved with respect to the pill cutter, so the pill will be split into two equal pieces.

### BACKGROUND OF THE INVENTION

### 1. Field of the Invention

The present invention relates to a cutting device, especially to a cutting device that is configured to cut a pill.

### 2. Description of the Prior Arts

Pills are manufactured in specific doses but different patients and different diseases need different dosages according to their respective prescriptions. For example, a dosage for a child may be half of a dosage for an adult. Therefore, the pill should be split into a suitable dose. Even though every pill has a notch formed thereon to facilitate splitting, a user still has difficulty cutting the pill along the notch because the pill is solid and hard. Thus, the pill may not be split into suitable doses.

Pill cutters are invented for this purpose. Conventionally, the pill cutter comprises a base, a lid, and a blade. The base forms a recess configured to receive a pill. The blade is mounted on the lid. After a pill is put in the recess of the base, the pill will be cut into two pieces by the blade upon closing of the lid on the base. However, because the pill cutter is configured to be used generally for various pills, the pills may not perfectly fit the pill cutter. As a result, the pill may be cut into two unequal pieces, which causes uneven doses for intakes of the pill.

Besides, the pills are manufactured in various shapes: circle, triangle, square, rhombus, etc. Moreover, some pills may have a special shape, for example, drop shape. Therefore, the conventional pill cutter cannot fix every pill stably, so the pill may be cut into two unequal pieces.

To overcome the shortcomings, the present invention provides a pill locator for a pill cutter to mitigate or obviate the aforementioned problems.

### SUMMARY OF THE INVENTION

The main objective of the present invention is to provide a pill locator for a pill cutter that assists the pill to be split into two equal pieces.

The pill cutter has a base, a lid, a blade, and a plurality of pill locators. The base forms a recess. The lid is tiltably mounted on the base and selectively closing the base. The blade is mounted on the lid. Each one of the pill locators is configured to be mounted in a pill cutter. The pill locator has a board, and the board forms an edge and at least one hole. The edge is configured to abut the recess of the pill cutter so that the board is fixed in the recess. The at least one hole is configured to receive a pill, and a shape and a size of the at least one hole corresponds to said pill. The holes of the pill locators differ from one another in shape or size; only one of the pill locators is mounted in the recess.

With the edge of the board abutting the recess of the pill cutter, the pill locater may not be moved with respect to the pill cutter. As a result, the pill in the pill locater is well positioned with respect to the pill cutter, so the pill will be split into two equal pieces. Moreover, different pill locators may have the holes with different shapes or sizes, so the user can choose a suitable pill locator according to a pill to be cut, and thereby the pill cutter can be utilized to cut various pills.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pill locator in accordance with a first embodiment of the present invention;

FIG. 2 is a perspective view of the pill locator in FIG. 1 shown with a conventional pill cutter;

FIG. 3 is a sectional view of the pill locator in FIG. 1 shown with the conventional pill cutter;

FIG. 4 is another sectional view of the pill locator in FIG. 1 shown with the conventional pill cutter;

FIG. 5 is a perspective view of a pill locator in accordance with a second embodiment of the present invention;

FIG. 6 is a perspective view of a pill locator assembly shown with various pill locators of the present invention; and

FIG. 7 is a perspective view of another pill locator assembly shown with various pill locators of the present invention.

### DETAILED DESCRIPTION OF THE PREFERRED EMBODIMENTS

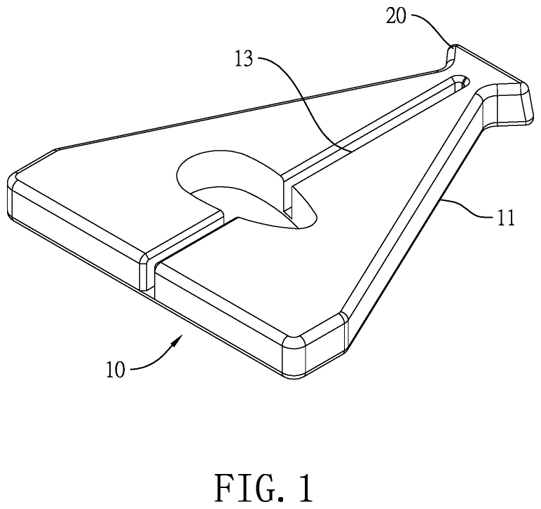

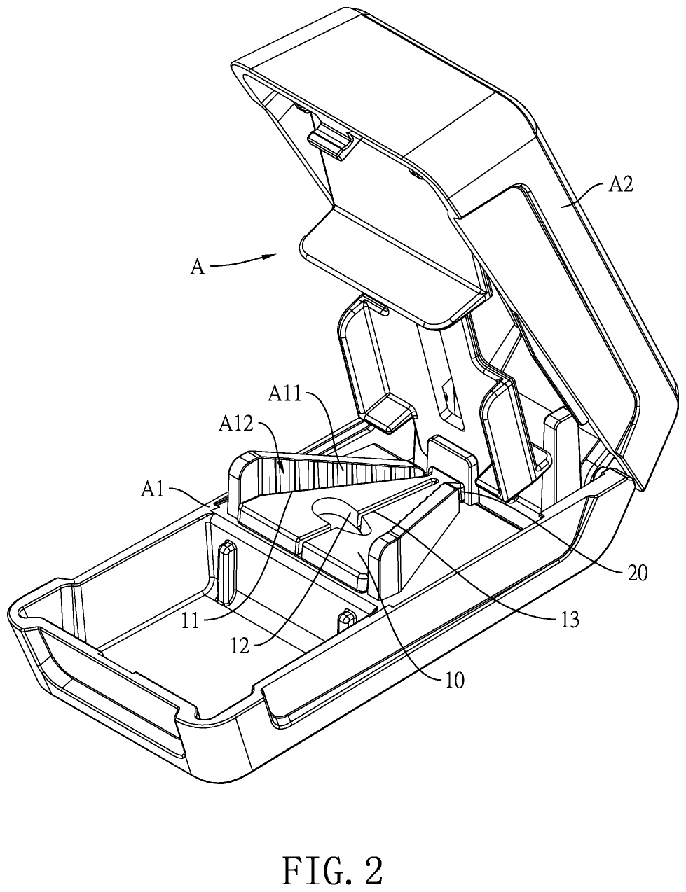

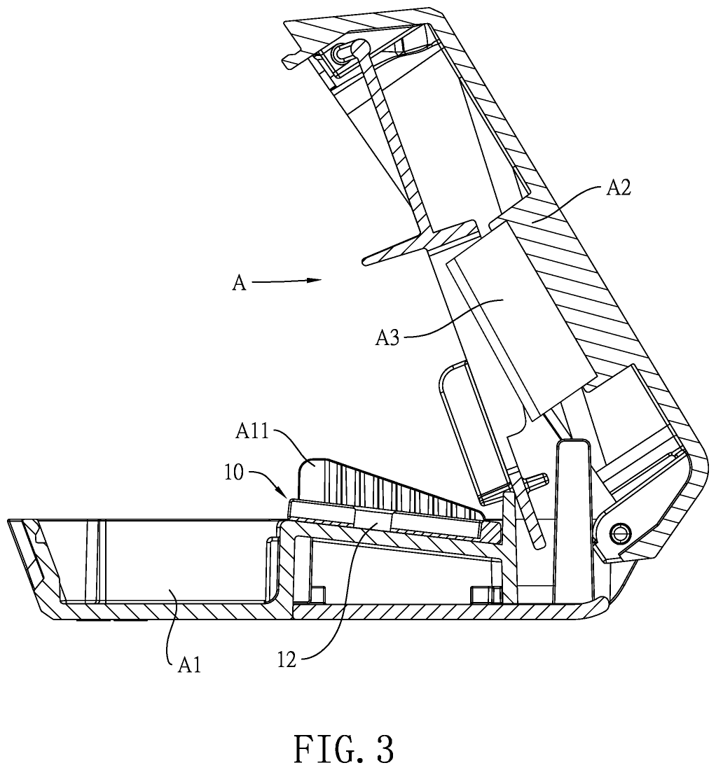

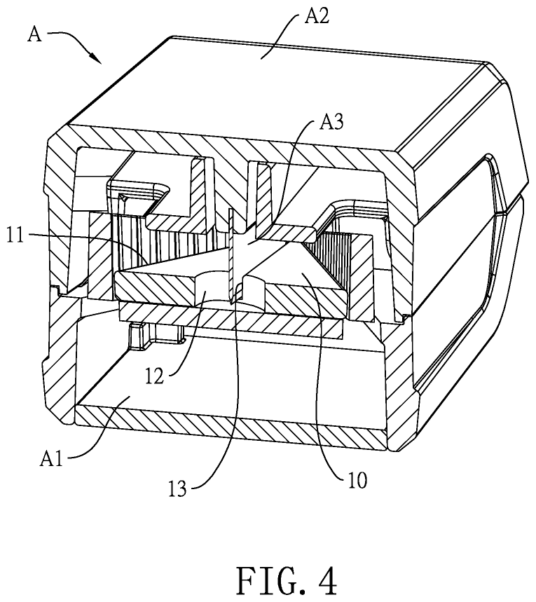

Please refer to FIG. 1 to FIG. 4. A pill locator is provided according to a first embodiment of the present invention. The pill locator is configured to assemble on a conventional pill cutter A. The pill cutter A comprises a base A1, a lid A2, and a blade A3. The blade A3 is mounted on the lid A2 and the base A1 forms a recess A12 configured to receive a pill. Precisely, the base A1 has two lateral walls A11 and the recess A12 is formed between the two lateral walls A11. Conventionally, the recess A12 is configured to receive a pill directly, but, in the present invention, the pill locator is assembled in the recess A12 and then the pill is received by the pill locator.

The pill locator is configured to be mounted in the recess A12 and comprises a board 10. The pill locator may further comprise at least one protrusion 20, and in this embodiment, a number of the at least one protrusion 20 is two.

The board 10 forms an edge 11 and at least one hole 12, and selectively forms a slot 13. The edge 11 has a contour enclosing the board 10 and is configured to abut the recess A12 of the pill cutter A so that the board 10 is fixed in the recess A12. Precisely, the edge 11 of the board 10 comprises two sides and the two sides are configured to respectively abut the two lateral walls A11 of the pill cutter A at the same time, and thereby the pill locator is stably fixed in the recess A12. The board 10 has a corner located between the two sides of the edge 11 and an angle of the corner is equal to an angle between the two lateral walls A11 of the recess A12 of the pill cutter A so that the pill locator is fit in the recess A12.

Each one of the at least one hole 12 is configured to receive one pill and a shape and a size of the at least one hole 12 corresponding to a shape and a size of said pill. In this embodiment, a number of the at least one hole 12 is one. A shape of a sectional area of the hole 12 may be a circle, triangle, square, rhombus, oval, ellipse, bar-shape, or drop-shape, etc. However, the shape of the hole 12 is not limited thereto and may be any shape according to the shape of the various pills. Therefore, the pill is positioned in the hole 12 and thereby the pill locater prevents the pill from moving. In this embodiment, the hole 12 is a through hole, but it is not limited thereto, as the hole 12 may be a blind hole.

The slot 13 is configured to receive a blade A3 of the pill cutter A and communicates with the hole 12. The hole 12 is divided into two portions according to the slot 13 and areas of the two portions are equal to each other. Therefore, when the blade A3 is moved into the slot 13, the pill in the hole 12 is cut into two equal pieces.

The at least one protrusion 20 is mounted on the board 10 so that the at least one protrusion 20 and the board 10 clamp the lateral wall(s) A11 of the recess A12. A number of the at least one protrusion 20 is two, but the number may be one and is not limited thereto. Each one of the protrusions 20 is mounted on the board 10, located at the corner which is between the two sides of the edge 11. In this embodiment, each one of the protrusions 20 protrudes out of the recess A12 of the pill cutter A so that the at least one protrusion 20 and the board 10 clamp the two lateral walls A11 of the recess A12. In another embodiment, the number of the protrusions 20 may be more than two and the multiple protrusions 20 may clamp the lateral wall(s) A11 of the recess A12, which makes the pill locator more stable. Precisely, the two protrusions 20 protrude parallel with the board 10, and in this embodiment, protrude away from each other.

With the present invention, before a user cuts a pill, the pill locator can be assembled on a conventional pill cutter A, the pill is put into the hole 12 of the pill locator. Because the pill is fittingly positioned with the hole 12, the pill may not be moved with respect to the pill locator. With the two sides of the edge 11 of the board 10 abutting the lateral walls A11 of the pill cutter A, the pill locater may not be moved with respect to the pill cutter A in a direction perpendicular to the blade A3. With the protrusions 20 and the board 10 clamping the lateral walls A11, the pill locater may not be moved with respect to the pill cutter A in a direction parallel to the blade A3. As a result, the pill in the pill locater may not be moved with respect to the pill cutter A, so the pill will be split into two equal pieces.

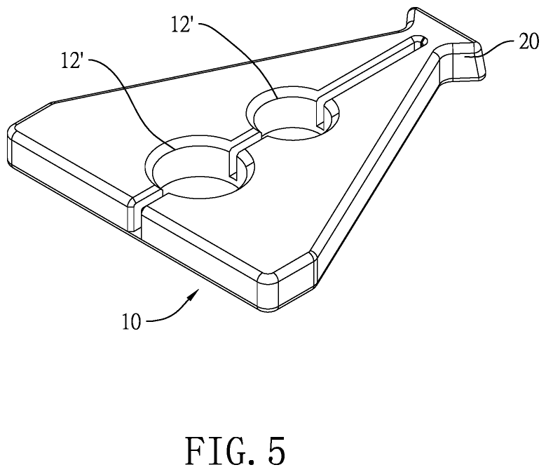

Then please refer to FIG. 5. Another pill locator is provided according to a second embodiment of the present invention. The second embodiment is similar to the first embodiment, but one of the differences is that the board 10 forms two holes 12′. The two holes 12′ may have different sizes or different shapes so that one pill locator can be used for two different pills. However, the two holes 12′ may have the same size and the same shape so that two same pills may be cut simultaneously.

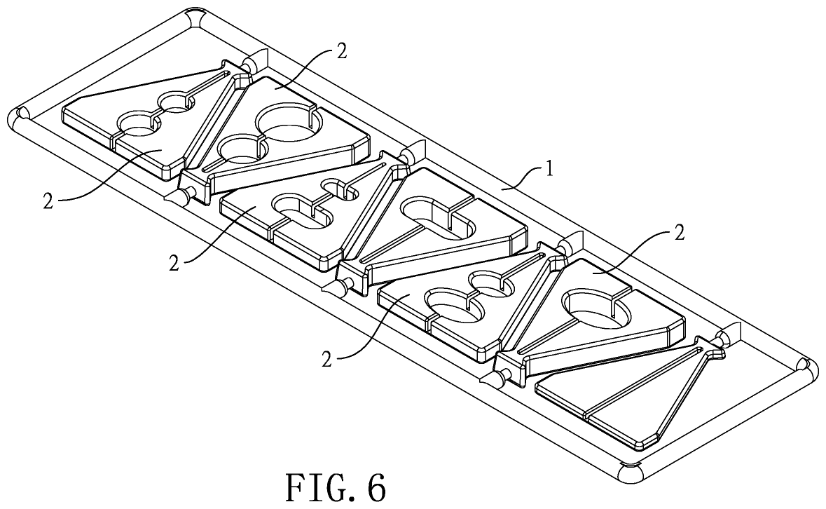

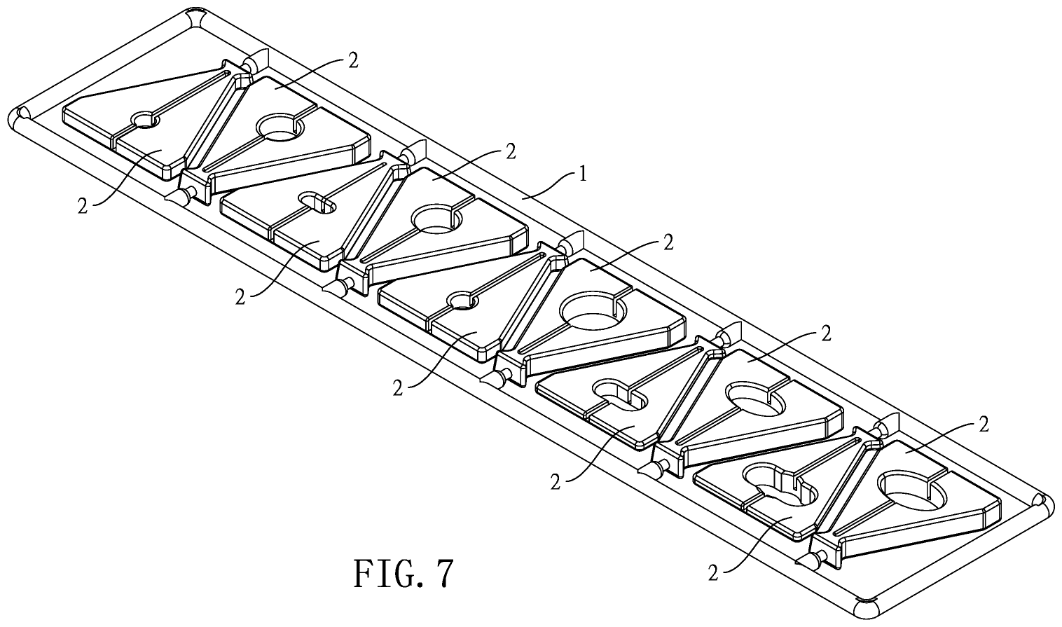

Then please refer to FIGS. 6 and 7. A pill locator assembly is also provided. The pill locator assembly comprises a frame 1 and a plurality of pill locators 2 detachably mounted on the frame 1 and the holes of each pill locator 2 are different from the holes of any other pill locator 2 in shape and size. For example, the pill locators 2 on the pill locator assembly may have circular holes 12 of different sizes, or the pill locators 2 on the pill locator assembly may have elliptical holes 12 of different sizes. Only one of the pill locators 1 is mounted in the recess each time for cutting.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pill locator configured to be mounted in a pill cutter, the pill cutter forming a recess; the pill locator comprising a board, the board forming:
an edge configured to abut the recess of the pill cutter so that the board is fixed in the recess;
at least one hole configured to receive a pill, and a shape and a size of the at least one hole corresponding to said pill.

2. The pill locator as claimed in claim 1, wherein the edge of the board comprises:
two sides configured to respectively abut two lateral walls of the recess of the pill cutter at the same time.

3. The pill locator as claimed in claim 2, wherein the board comprises:
a corner located between the two sides of the edge of the board and an angle of the corner being equal to an angle between the two lateral walls of the recess of the pill cutter.

4. The pill locator as claimed in claim 1, wherein the pill locator further comprises:
at least one protrusion formed on the board so that the at least one protrusion engages with the pill cutter and thereby the pill locator is fixed on the pill cutter.

5. The pill locator as claimed in claim 3, wherein the pill locator further comprises:
at least one protrusion formed on the board, located at the corner between the two sides of the edge, protruding out of the recess of the pill cutter so that the at least one protrusion and the board clamp the two lateral walls of the recess.

6. The pill locator as claimed in claim 5, wherein the at least one protrusion includes two said protrusions, and the two protrusions protrude away from each other.

7. The pill locator as claimed in claim 4, wherein the at least one protrusion protrudes parallel with the board.

8. The pill locator as claimed in claim 5, wherein the at least one protrusion protrudes parallel with the board.

9. The pill locator as claimed in claim 1, wherein the shape of the at least one hole is a circle, triangle, square, rhombus, oval, ellipse, bar-shape, or drop-shape.

10. The pill locator as claimed in claim 8, wherein the shape of the at least one hole is a circle, triangle, square, rhombus, oval, ellipse, bar-shape, or drop-shape.

11. The pill locator as claimed in claim 1, wherein the board further forms:
a slot configured to receive a blade of the pill cutter and communicating with the at least one hole.

12. The pill locator as claimed in claim 10, wherein the board further forms:
a slot configured to receive a blade of the pill cutter and communicating with the at least one hole.

13. The pill locator as claimed in claim 11, wherein each one of the at least one hole is divided into two portions by the slot and areas of the two portions are equal to each other.

14. The pill locator as claimed in claim 12, wherein each one of the at least one hole is divided into two portions by the slot and areas of the two portions are equal to each other.

15. A pill cutter comprising:
a base forming a recess;
a lid tiltably mounted on the base and selectively closing the base;
a blade mounted on the lid; and
a plurality of pill locators detectably mounted in the recess, each one of the pill locators comprising a board, the board forming:
an edge configured to abut the recess of the pill cutter so that the board is fixed in the recess;
at least one hole configured to receive a pill, a shape and a size of the at least one hole corresponding to a shape and a size of said pill;
wherein the holes of the pill locators differ from one another in shape or size; only one of the pill locators is mounted in the recess.
